(19) United States
(12) Patent Application Publication
(10) Pub. No.: US 2006/0149547 A1
(43) Pub. Date: Jul. 6, 2006

(54) Recording apparatus and voice recorder program

(75) Inventor: Takao Miyazaki, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/324,584

(22) Filed: Jan. 4, 2006

(30) Foreign Application Priority Data
Jan. 6, 2005 (JP) 2005-001471

(51) Int. Cl. G10L 17/00

(52) U.S. Cl. 704/247

(57) ABSTRACT

The present invention provides a recording apparatus and voice recorder program that can selectively record the voice of a specific speaker and can also convert voice into text for each speaker and record the resulting text. The recording apparatus comprises: a voice input device for inputting a voice of a speaker; a voice print registration device which registers a voice print of the speaker; a voice extraction device which filters voices input by the voice input device to extract a voice corresponding to the voice print registered in the voice print registration device; and a recording device which records the extracted voice.

### BACKGROUND OF THE INVENTION

1. Field of the Invention

The present invention relates to a recording apparatus and a voice recorder program, and more particularly to a recording apparatus and a voice recorder program that digitize and record a voice.

2. Description of the Related Art

Technology has already been developed that converts speech that was input through a microphone or the like into characters and outputs data comprising the resulting characters. For example, Japanese Patent Application Laid-Open No. 2003-178158 discloses a print service system that stores conversation or question and answer exchanges as characters for use as evidence data and prints the characters.

### SUMMARY OF THE INVENTION

However, when converting speech into characters and outputting the characters as described above, adverse effects may occur when the voice of a person other that the principal speaker or background noise input through the microphone is also converted into characters and thus prevents accurate conversion into characters or the like. Further, in the above described Japanese Patent Application Laid-Open No. 2003-178158, a device that distinguishes the voice or characters for each speaker was not specifically disclosed.

The present invention was made in view of the above described circumstances, and it is an object of the invention to provide a recording apparatus and voice recorder program that can selectively record the voice of a specific speaker and can also convert voice into text for each speaker and record the resulting text.

In order to achieve the above object, a recording apparatus according to a first aspect of this invention comprises a voice input device for inputting a voice of a speaker, a voice print registration device which registers a voice print of the speaker, a voice extraction device which filters voices input by the voice input device and extracts a voice corresponding to the voice print registered in the voice print registration device, and a recording device which records the extracted voice.

According to the recording apparatus of the first aspect, it is possible to filter noise and the voices of people other than the speaker that the user wishes to record, to thereby record only the voice of the speaker whose voice print was registered.

A recording apparatus of a second aspect of this invention is an apparatus according to the first aspect, wherein voice prints of a plurality of speakers and speaker identification information that identifies the speakers are associated and registered in the voice print registration device, and the recording device records in a distinguishable condition voices that were extracted for each of the speakers. According to the recording apparatus of the second aspect, a voice can be recorded separately for each speaker (for example, in a voice file for each speaker).

A recording apparatus of a third aspect of this invention is an apparatus according to the second aspect, further comprising an extraction voice designation device which selects the speaker identification information to designate the voice of a speaker to be extracted by the voice extraction device. According to the recording apparatus of the third aspect, it is possible to select the voice of the speaker to be recorded.

A recording apparatus of a fourth aspect of this invention comprises a voice input device for inputting a voice of a speaker, a speaker direction calculation device which calculates a direction in which a speaker that emitted the voice is present based on the voice that was input, and a recording device which associates and records the direction of the speaker and the voice.

According to the recording apparatus of the fourth aspect, it is possible to record a voice for each speaker by recording the direction in which the speaker is present together with the voice.

A recording apparatus of a fifth aspect of this invention is an apparatus according to the fourth aspect, wherein the voice input device consists of a plurality of microphones, and the speaker direction calculation device calculates the direction in which the speaker is present based on differences in volumes of voices that were input from the plurality of microphones. The fifth aspect limits the speaker direction calculation device to a plurality of microphones.

A recording apparatus of a sixth aspect of this invention is an apparatus according to any one of the first to fifth aspects, further comprising a text data generation device which converts the input voice into text data and a text recording device that records the text data, wherein when voices of a plurality of speakers were input the text data generation device generates the text data for each of the speakers.

According to the recording apparatus of the sixth aspect, a voice can be recorded as text data. Further, by adding identification information for the speaker (for example, the speaker's name or the like) to the generated text data or separating the text for each speaker, it is possible to recognize who spoke by referring to the text data.

A recording apparatus of a seventh aspect of this invention is an apparatus according to the sixth aspect, further comprising an output device which outputs the text data. The recording apparatus according to the seventh aspect comprises an output device that prints or displays text data.

A recording apparatus of a eighth aspect of this invention is an apparatus according to the seventh aspect, wherein the output device outputs the text data such that the speaker can be distinguished by at least one member of the group consisting of a font, a font size, a color, a background color, a character decoration and a column of characters of the text data.

According to the recording apparatus of the eighth aspect, it is easy to recognize who spoke from the output text data.

A recording apparatus of a ninth aspect of this invention is an apparatus according to the seventh or eighth aspect, wherein the output device is a printer which prints the text data. The ninth aspect limits the output device of the seventh and eighth aspects to a printer.

A recording apparatus of a tenth aspect of this invention is an apparatus according to any one of the sixth to ninth aspects, further comprising a text editing device for editing the text data.

According to the recording apparatus of the tenth aspect, it is possible to edit text data when there is a mistake in the text due to incorrect voice recognition or the like.

A voice recorder program according to a eleventh aspect of this invention causes a computer to implement a voice input function which inputs voices of speakers, a voice print registration function which registers voice prints of the speakers, a voice extraction function which filters the voices that were input to extract voices corresponding to the registered voice prints, and a recording function which records the extracted voices.

Further, a voice recorder program according to a twelfth aspect of this invention causes a computer to implement a voice input function which inputs voices of speakers, a speaker direction calculation function which calculates the directions in which the speakers that emitted the voices are present based on the input voices, and a recording function which associates and records the directions of the speakers and the voices.

According to this invention, since the voice of a specific speaker can be selectively recorded, it is possible to prevent background noise or the voices of people other than the principal speaker or the like from being converted into text or to prevent inaccurate text conversion being performed. It is also possible to record a voice for each speaker by utilizing voice print determination or based on the direction in which the speaker is present.

### BRIEF DESCRIPTION OF THE DRAWINGS

FIG. 1 is an outline drawing showing a recording apparatus according to one embodiment of this invention;

FIG. 2 is a block diagram showing the principal configuration of a recording apparatus according to the first embodiment of this invention;

FIG. 3 is a flowchart illustrating a voice print registration method;

FIG. 4 is a flowchart illustrating a voice recording method of the first embodiment of this invention;

FIG. 5 is a flowchart illustrating a voice recording method of the first embodiment of this invention (continuation of FIG. 4);

FIG. 6 is a view that schematically shows an example of voice analysis;

FIG. 7 is a view that schematically shows an example of recording voices using the recording apparatus of one embodiment;

FIG. 8 is a view showing an example of text data;

FIG. 9 is a view showing an example of text data;

FIG. 10 is a block diagram illustrating the configuration of a recording apparatus according to the second embodiment of this invention;

FIG. 11 is a flowchart illustrating a voice recording method of the second embodiment of this invention; and

FIG. 12 is a flowchart illustrating a voice recording method of the second embodiment of this invention (continuation of FIG. 11).

### DETAILED DESCRIPTION OF THE PREFERRED EMBODIMENTS

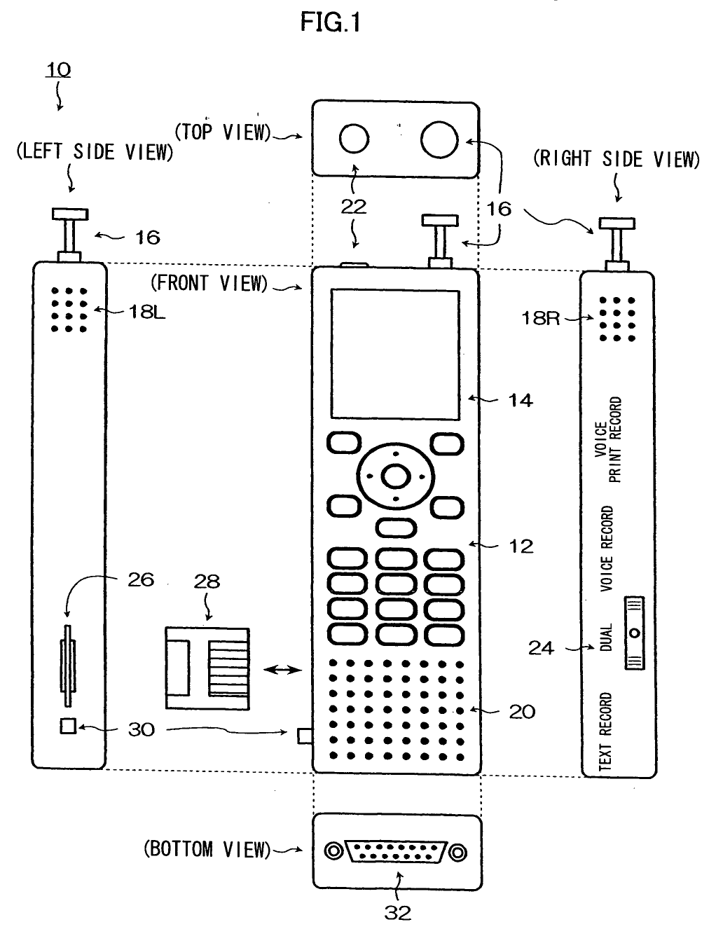

Hereunder, preferred embodiments of the recording apparatus and voice recorder program of this invention are described in accordance with the attached drawings. FIG. 1 is an outline drawing showing a recording apparatus according to one embodiment of this invention. A recording apparatus 10 shown in the figure comprises a group of various switches 12 that includes a ten-key configuration, a monitor (LCD monitor) 14 and an antenna 16 for communication with a base station of a mobile telephone. The recording apparatus 10 also serves as a mobile telephone.

As shown in FIG. 1, on the left and right sides of the recording apparatus 10 are respectively disposed microphones 18 (left microphone 18L and right microphone 18R) for conducting a telephone call or recording speech. On the lower part of the front of the recording apparatus 10 is provided a speaker 20 for use when conducting a telephone call or for playing back speech that was recorded by the microphones 18.

Reference numeral 22 on the top part of the recording apparatus 10 designates a recording switch that controls the start and end of recording. When the recording switch 22 is pressed down, recording of speech starts, and when the recording switch 22 is pressed down during recording the recording ends.

Reference numeral 24 on the right side of the recording apparatus 10 designates a mode setting switch for setting the recording mode. The mode setting switch 24 is a slide switch, and when the knob is moved in the upward direction of the figure, it sets the mode to text recording mode, dual mode, voice recording mode and voice print registration mode in that order. The mode selected by the mode setting switch 24 is displayed by the monitor 14. In this connection, a detailed description of each of the modes is provided later.

Reference numeral 26 on the left side of the recording apparatus 10 designates an external memory slot for inserting a recording medium 28. Reference numeral 30 designates an eject pin for removing the recording medium 28 from the external memory slot 26.

On the underside of the recording apparatus 10 is provided an external device connection interface (external device connection I/F) 32 for connecting the recording apparatus 10 with an external device (for example, a personal computer or printer).

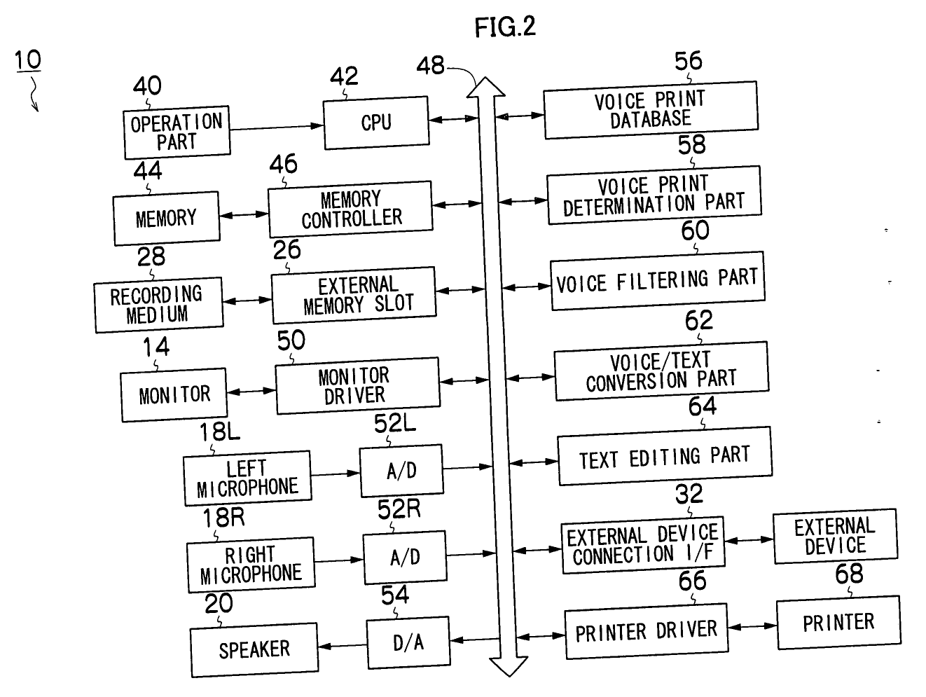

FIG. 2 is a block diagram showing the principal configuration of a recording apparatus according to the first embodiment of this invention. An operation part 40 shown in FIG. 2 is an operation entry part that includes the group of various switches 12, the recording switch 22, the mode setting switch 24 and the like. A CPU 42 is a centralized control part that controls each block within the recording apparatus 10 on the basis of operations input from the operation part 40 and the like. A memory 44 includes a ROM that stores programs that are processed by the CPU 42 and various data the CPU 42 requires to carry out control and the like and a RAM that serves as a work space for various operations and the like performed by the CPU 42. The memory 44 is connected to a data bus 48 through a memory controller 46.

As shown in FIG. 2, the aforementioned monitor 14, microphones 18 (18L and 18R), and speaker 20 are connected to the data bus 48 through a monitor driver 50, A/D converters 52 (52L and 52R) and a D/A converter 54, respectively.

The recording apparatus 10 also comprises a voice print database 56, a voice print determination part 58, a voice filtering part 60, a voice/text conversion part 62, a text editing part 64 and a printer driver 66.

The voice print database 56 is a function part that registers the voice print of a speaker. The voice print determination part 58 is a function part that determines whether a voice that was input from the microphones 18 matches a voice print that was previously registered in the voice print database 56. The voice filtering part 60 is a function part that filters voices that were input from the microphones 18 to extract a voice that matches a voice print that was registered in the voice print database 56.

The voice/text conversion part 62 is a function part that performs voice recognition processing for a voice extracted by the voice filtering part 60 to convert the voice into text data. Text data that was generated by the voice/text conversion part 62 is recorded on the recording medium 28. Further, when there is a plurality of speakers, the voice/text conversion part 62 arranges the text such that the correspondence between the text and the speaker can be distinguished visually by applying a modification to the text by means of the font, font size, color, background color, character decoration (for example, underline or bold type, italic type, hatching, highlighter pen, enclosed characters, character rotation, shaded characters, outline characters and the like) or columns.

The text editing part 64 is a function part for editing text data that was generated by the voice/text conversion part 62, and it includes an editor for editing text data on the basis of an input from hardware such as a personal computer, a keyboard or a monitor that is connected to the recording apparatus 10 through the external device connection I/F 32. In addition to the above described external devices, editing of text data can also be performed by operating the monitor 14 or the group of various switches 12.

The printer driver 66 is a function part that drives a printer 68 that was connected to the recording apparatus 10 through the external device connection I/F 32. Text data that was generated by the above described voice/text conversion part 62 can be printed by the printer 68.

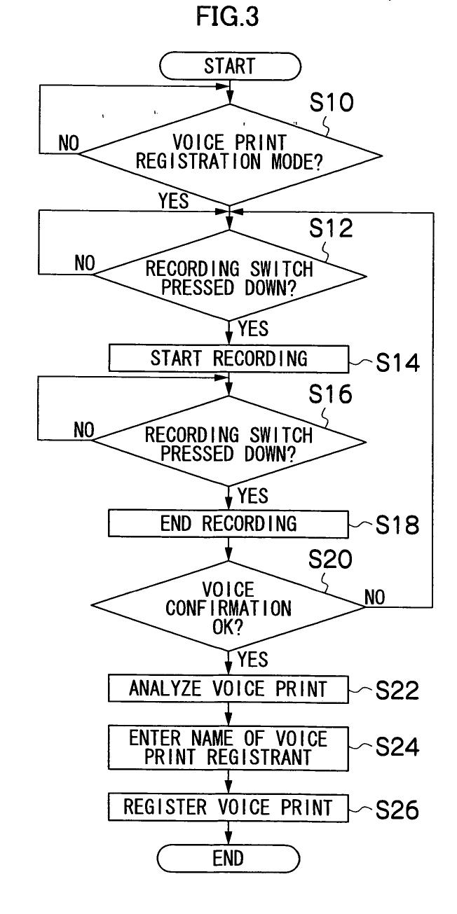

Next, a method for registering a voice print in the recording apparatus 10 will be described. FIG. 3 is a flowchart illustrating a method for registering a voice print.

First, when the knob of the mode setting switch 24 is moved to the voice print registration mode position, the CPU 42 detects that the voice print registration mode has been set (step S10). Subsequently, when the CPU 42 detects that the recording switch 22 was pressed down (step S12), speech is input through the microphones 18 to start voice recording (step S14). In step S14, for example, predetermined words or sentences for voice print recognition are read out by the speaker and recorded. Thereafter, when the CPU 42 detects that the recording switch 22 was pressed down (step S16), the recording ends (step S18).

Next, the voice that was recorded in the above described steps is played back and a selection screen is displayed to select whether to reconduct the recording or to register the recording that was played back (step 20). In step S20, when the speaker makes a selection on the selection screen to reconduct the recording because the recording that was played back was not satisfactory or the like, the operation of the selection screen is detected by the CPU 42 and the processing returns to step S12. In contrast, when the speaker selects in step S20 to register the recording that was played back, the voice print of the voice that was recorded is analyzed by the voice print determination part 58 (step S22). Subsequently, a screen for entering the name of the voice print registrant is displayed, the name of the voice print registrant that is entered is recognized by the CPU 42 (step S24), and the voice print is then registered in the voice print database 56 in association with the name of the voice print registrant (step S26).

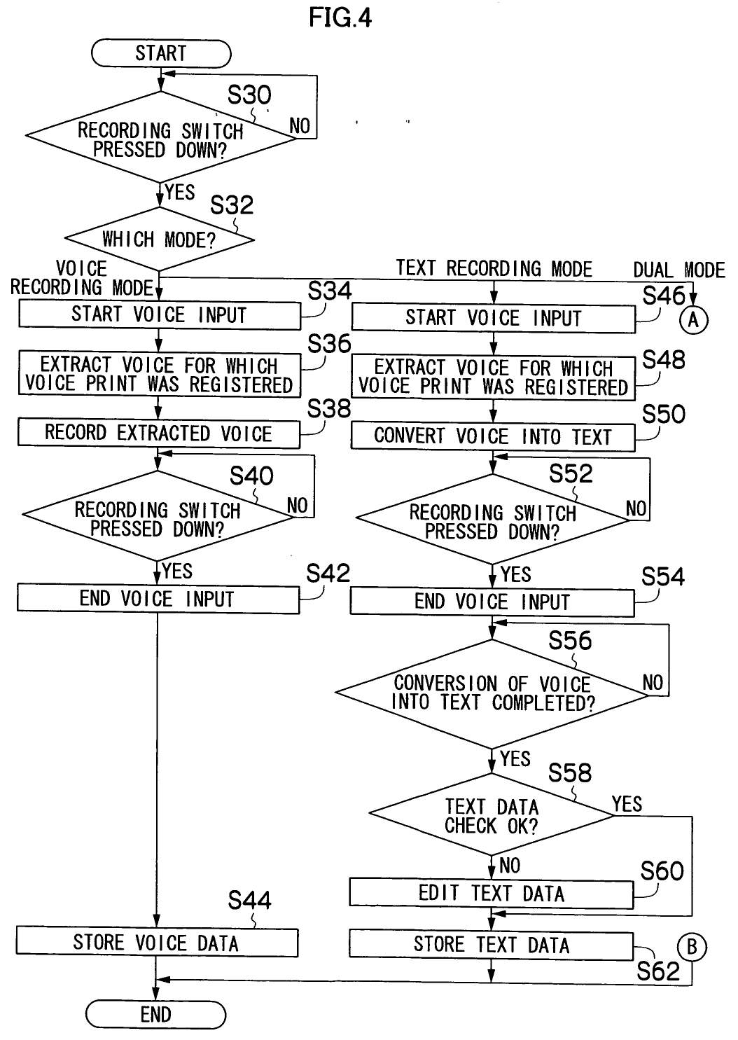

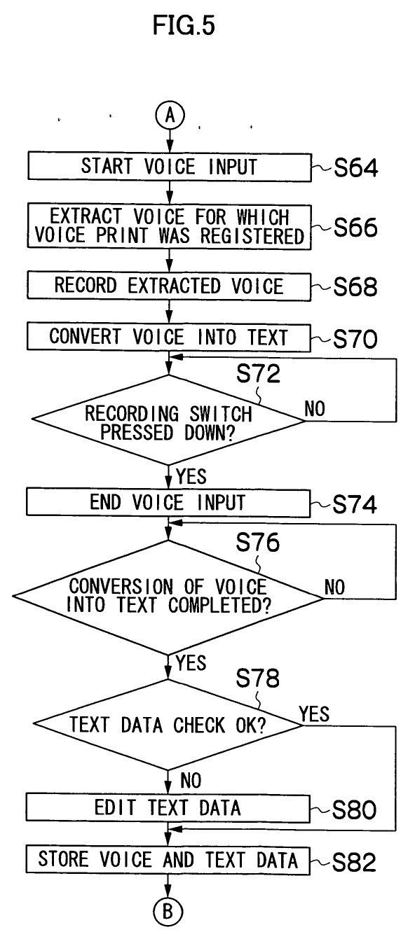

Next, a voice recording method will be described. FIG. 4 and FIG. 5 are flowcharts illustrating the voice recording method of the first embodiment of this invention.

First, when the CPU 42 detects that the recording switch 22 was pressed down (step S30), the CPU 42 detects the position of the knob of the mode setting switch 24 to identify which mode has been set (step S32).

When the CPU 42 detects in step S32 that the voice recording mode is set, the processing proceeds to step S34 to start voice input through the microphones 18. Next, the voices that were input through the microphones 18 are analyzed by the voice print determination part 58 and compared with the voice print registered in the voice print database 56. The voice that was registered in the voice print database 56 is then extracted from the input voices by the voice filtering part 60 (step S36), and the extracted voice is recorded (step S38).

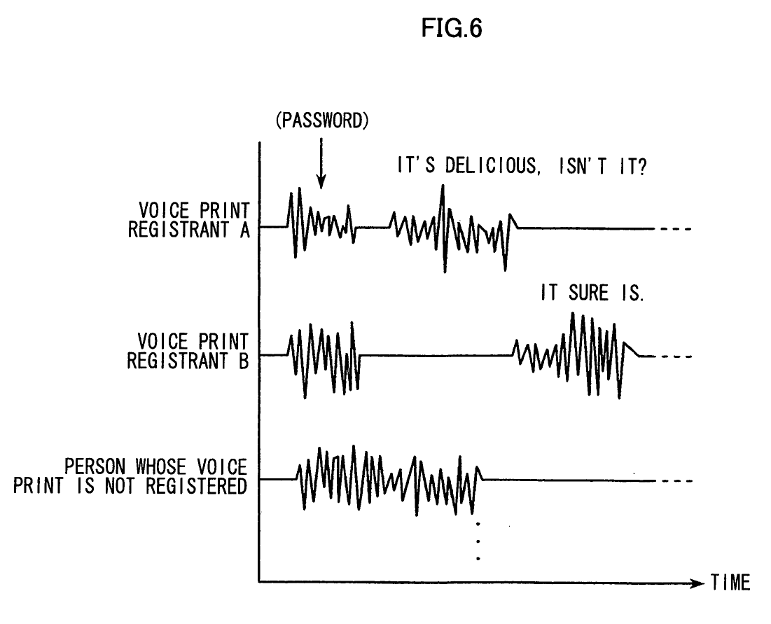

FIG. 6 is a view that schematically shows an example of voice analysis. As shown in FIG. 6, voices that were introduced from the microphones 18 is analyzed by the voice print determination part 58 and only the voice of the voice print registrant is extracted.

In this connection, according to this embodiment, a configuration may be adopted whereby each speaker says a predetermined password (for example, a name) when commencing the voice input of step S34 to thereby begin voice recognition for the speaker corresponding to the respective password.

Returning to the description of the flowchart of FIG. 4, the processing then proceeds to step S40. When the CPU 42 detects that the recording switch 22 was pressed down the voice input ends (step S42) and the recorded voice data is stored on the recording medium 28 (step S44). In step S44, the names of the voice print registrants and the voice data are associated together and stored (for example, in a separate voice file for each voice print registrant).

In contrast, when the text recording mode is set in step S32, the processing proceeds to step S46 to begin voice input through the microphones 18. Next, the voice that was registered in the voice print database 56 is extracted from the voices that were input through the microphones 18 by the voice filtering part 60 (step S48), and the extracted voice is converted into text data by the voice/text conversion part 62 (step S50). When the CPU 42 subsequently detects that the recording switch 22 was pressed down (step S52) the voice input ends (step S54).

Thereafter, when conversion of the extracted voice to text data ends (step S56), the text data is displayed on the monitor 14 or a personal computer or a monitor or the like connected through the external device connection I/F 32 and a confirmation screen is displayed to confirm whether or not to edit the text data (step S58). When the user selected to edit the text data in step S58, editing of the text data is conducted through the group of various switches 12 or a personal computer or keyboard connected through the external device connection I/F 32 (step S60), and the voice data and text data is then stored on the recording medium 28 (step S62). In contrast, when the user selected to store the text data in step S58, the text data is stored as it is on the recording medium 28 (step S62).

When the dual mode has been set in step S32, the processing proceeds to step S64 of FIG. 5 to commence voice input. The voice filtering part 60 then extracts the voice registered in the voice print database 56 from the voices introduced through the microphones 18 (step S66), the extracted voice is recorded (step S68), and the extracted voice is also converted to text data by the voice/text conversion part 62 (step S70). Thereafter, when the CPU 42 detects that the recording switch 22 was pressed down (step S72) the voice input ends (step S74).

Subsequently, when conversion of the extracted voice into text data ends (step S76), the text data is displayed on the monitor 14 or the like and a confirmation screen is displayed to confirm whether or not to edit the text data (step S78). When the user selected to edit the text data in step S78, editing of the text data is conducted (step S80) and the voice data and text data are stored on the recording medium 28 (step S82). In contrast, when the user selected to store the text data in step S78, the text data is stored as it is on the recording medium 28 (step S82).

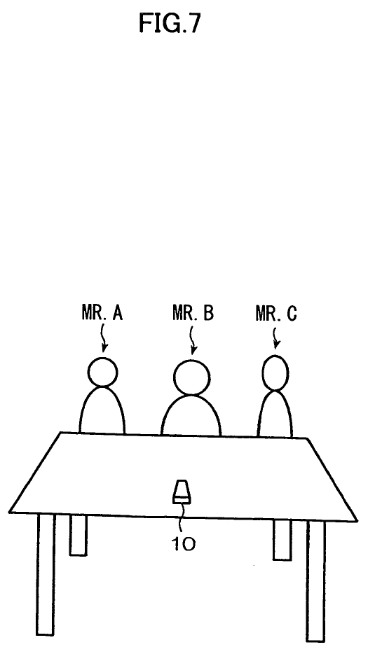

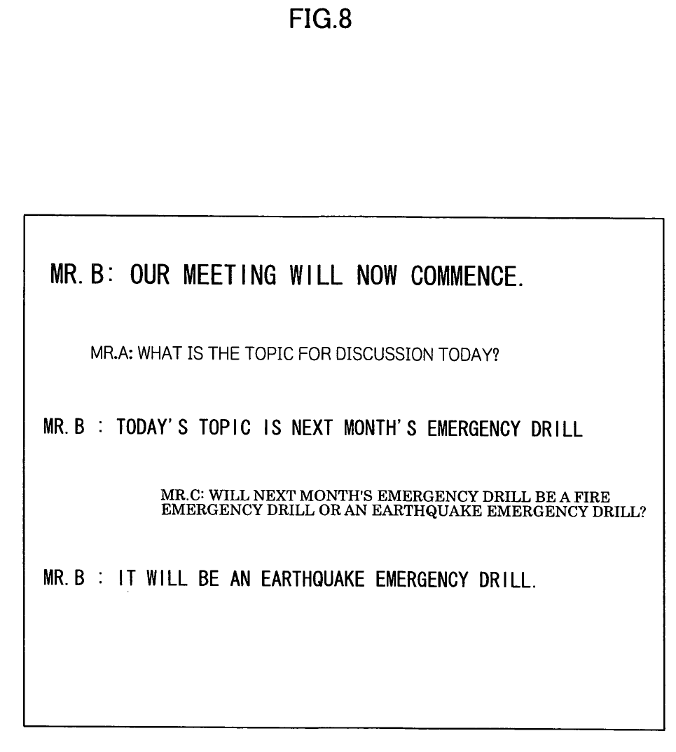

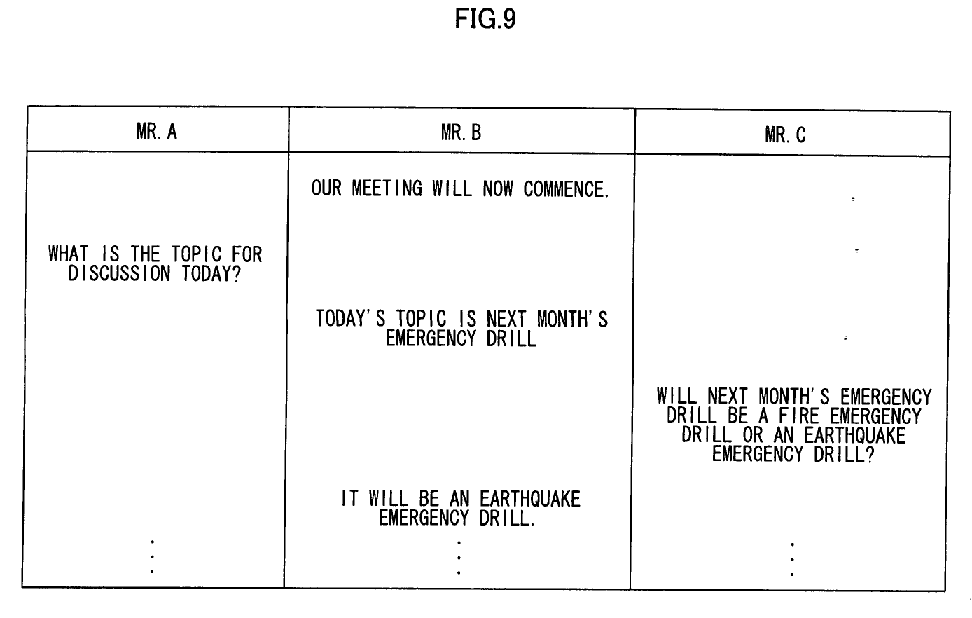

FIG. 7 is a view that schematically illustrates an example of recording voices using the recording apparatus of this embodiment. FIG. 8 and FIG. 9 are views showing examples of text data. In the example illustrated in FIG. 7, the voice prints of three people, Mr. A, Mr. B and Mr. C, are registered, in the voice print database 56 of the recording apparatus 10, and the recording apparatus 10 selectively records the voices of these three people.

In the example illustrated in FIG. 8, text is arranged together with the name of the voice print registrant in a time sequence (in the order of speaking), and the voice of each speaker is recorded in a different font. In this example, Mr. A's voice is recorded in Gothic type, Mr. B's voice is recorded in round Gothic type and Mr. C's voice is recorded in century type. Further, the position of the beginning of the line is changed for each speaker and the font size differs according to the volume of the voice. In the example illustrated in FIG. 9 the text is separated into columns for each speaker.

According to this embodiment, the voice of a specific speaker can be selectively recorded. It is thus possible to prevent background noise or the voices of people other than the principal speaker or the like that were input through the microphones 18 from being converted into text and also to prevent text conversion being carried out inaccurately. The voice of each speaker can also be recorded utilizing voice print determination.

In this connection, according to this embodiment the voice of only a specific speaker can be selectively recorded by designating the name of a voice print registrant that was registered in the voice print database 56.

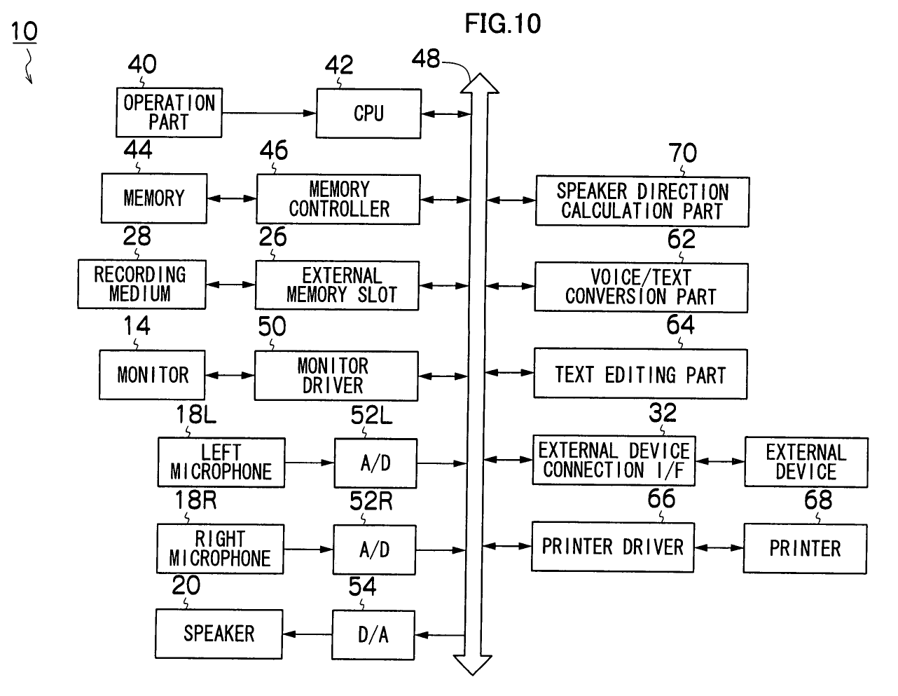

Next, the second embodiment of this invention will be described. FIG. 10 is a block diagram showing the configuration of a recording apparatus according to the second embodiment of this invention. In the following description, components that are the same as those in the above described embodiment are designated by the same symbols as above and a description of these components is omitted.

The recording apparatus 10 of this embodiment includes a speaker direction calculation part 70. The speaker direction calculation part 70 is a function part that calculates the relative positions of speakers based on a difference in the volume of the same voice that was input through the left and right microphones 18. In this embodiment, the voice of each speaker is recorded based on the position of the speaker that was calculated by the speaker direction calculation part 70.

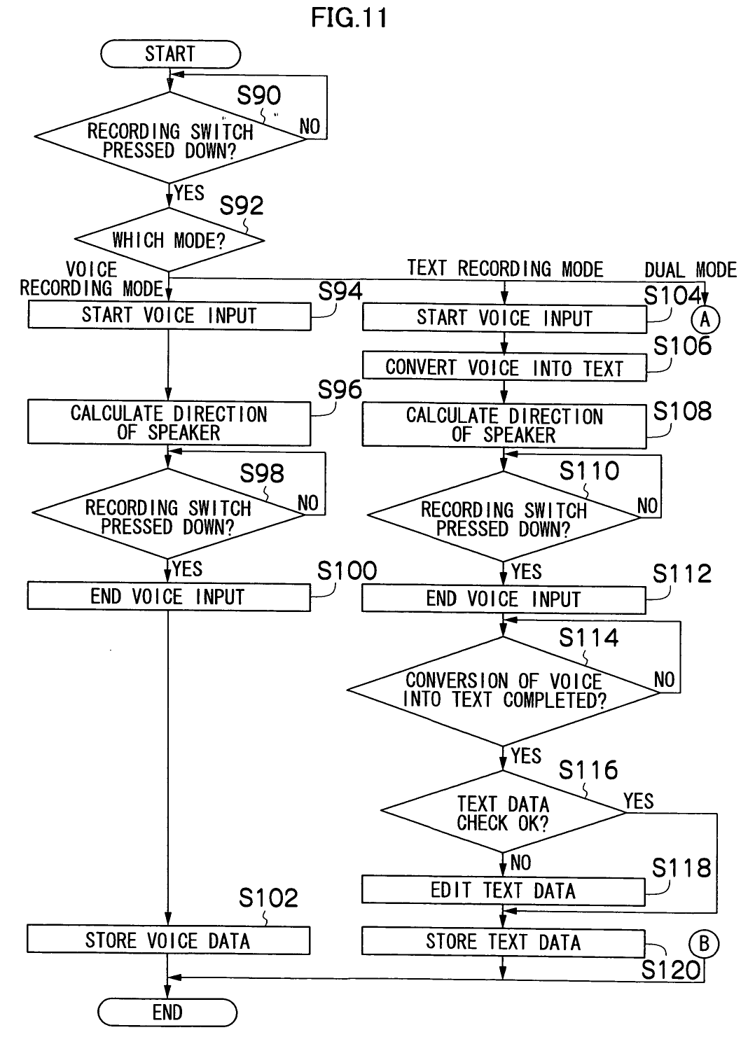

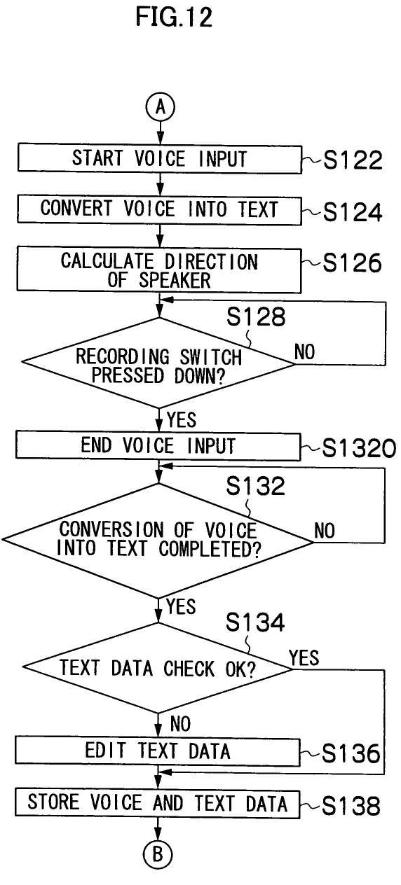

Next, the voice recording method of this embodiment is described. FIG. 11 and FIG. 12 are flowcharts illustrating the voice recording method of the second embodiment of this invention.

First, when the CPU 42 detects that the recording switch 22 was pressed down (step S90), the CPU 42 detects the position of the knob of the mode setting switch 24 to identify which mode has been set (step S92).

When the CPU 42 detects in step S92 that the voice recording mode is set, the processing proceeds to step S94 to start voice input through the microphones 18, and the direction in which each speaker is present is then calculated by the speaker direction calculation part 70 (step S96). Thereafter, when the CPU 42 detects that the recording switch 22 was pressed down (step S98), the recording ends (step S100) and the recorded voice data is stored on the recording medium 28 (step S102). In step S102, the directions in which the speakers are present and the voice data are associated together and stored (for example, in a separate voice file for each direction).

In contrast, when the text recording mode is set in step S92, the processing proceeds to step S104 to begin voice input through the microphones 18. The voices that were introduced through the microphones 18 are then converted to text data by the voice/text conversion part 62 (step S106) and the direction in which each speaker is present is also calculated by the speaker direction calculation part 70 (step S108). When the CPU 42 detects that the recording switch 22 was pressed down again (step S110), the voice input ends (step S112).

Subsequently, when conversion of the voices to text data ends (step S114) the text data is displayed on the monitor 14 or the like and a confirmation screen is displayed to confirm whether or not to edit the text data (step S116). When the user selected to edit the text data in step S116, editing of the text data is conducted (step S118) and the voice data and text data are stored on the recording medium 28 (step S120). In contrast, when the user selected to store the text data in step S116, the text data is stored as it is on the recording medium 28 (step S120).

When the dual mode is set in step S92, the processing proceeds to step S122 of FIG. 12. Since the processing from step S124 to S132 is the same as the above described processing from step S106 to step S114, a description thereof is omitted here. In step S134, when conversion of the voices to text ends, the text data is displayed on the monitor 14 or the like and a confirmation screen is displayed to confirm whether or not to edit the text data. When the user selected to edit the text data in step S134, editing of the text data is conducted (step S136) and the voice data and text data are stored on the recording medium 28 (step S138). In contrast, when the user selected to store the text data in step S134, the text data is stored as it is on the recording medium 28 (step S138).

According to this embodiment, similarly to the above described embodiment, speech can be converted to text and recorded for each speaker. In this connection, although in this embodiment the positions of speakers are calculated using two microphones (the left microphone 18L and the right microphone 18R), the number of microphones is not limited thereto.

What is claimed is:

1. A recording apparatus comprising:
a voice input device for inputting a voice of a speaker;
a voice print registration device which registers a voice print of the speaker;
a voice extraction device which filters voices input by the voice input device to extract a voice corresponding to the voice print registered in the voice print registration device; and
a recording device which records the extracted voice.

2. The recording apparatus according to claim 1, wherein voice prints of a plurality of speakers and speaker identification information that identifies the speakers are associated and registered in the voice print registration device, and the recording device records in a distinguishable condition respective voices that were extracted for each of the speakers.

3. The recording apparatus according to claim 2, further comprising an extraction voice designation device which selects the speaker identification information to designate a voice of a speaker to be extracted by the voice extraction device.

4. A recording apparatus comprising:
a voice input device for inputting a voice of a speaker;
a speaker direction calculation device which calculates a direction in which the speaker that emitted the voice is present based on the voice that was input; and
a recording device which associates and records the direction of the speaker and the voice.

5. The recording apparatus according to claim 4, wherein the voice input device comprises a plurality of microphones, and the speaker direction calculation device calculates the direction in which the speaker is present based on a difference in the volume of the voice that was input from the plurality of microphones.

6. The recording apparatus according to claim 1, further comprising:
a text data generation device which converts the input voice into text data; and
a text recording device which records the text data;
wherein when voices of a plurality of speakers were input the text data generation device generates the text data for each of the speakers.

7. The recording apparatus according to claim 2, further comprising:
a text data generation device which converts the input voice into text data; and
a text recording device which records the text data;
wherein when voices of a plurality of speakers were input the text data generation device generates the text data for each of the speakers.

8. The recording apparatus according to claim 3, further comprising:
a text data generation device which converts the input voice into text data; and
a text recording device which records the text data;
wherein when voices of a plurality of speakers were input the text data generation device generates the text data for each of the speakers.

9. The recording apparatus according to claim 4, further comprising:
a text data generation device which converts the input voice into text data; and
a text recording device which records the text data;
wherein when voices of a plurality of speakers were input the text data generation device generates the text data for each of the speakers.

10. The recording apparatus according to claim 5, further comprising:
a text data generation device which converts the input voice into text data; and
a text recording device which records the text data;
wherein when voices of a plurality of speakers were input the text data generation device generates the text data for each of the speakers.

11. The recording apparatus according to claim 6, further comprising an output device that outputs the text data.

12. The recording apparatus according to claim 11, wherein the output device outputs the text data such that the speaker can be distinguished by at least one member of the group consisting of a font, a font size, a color, a background color, a character decoration and a column of characters of the text data.

13. The recording apparatus according to claim 11, wherein the output device is a printer that prints the text data.

14. The recording apparatus according to claim 12, wherein the output device is a printer that prints the text data.

15. The recording apparatus according to claim 6, further comprising a text editing device for editing the text data.

16. The recording apparatus according to claim 11, further comprising a text editing device for editing the text data.

17. The recording apparatus according to claim 12, further comprising a text editing device for editing the text data.

18. The recording apparatus according to claim 13, further comprising a text editing device for editing the text data.

19. A voice recorder program that causes a computer to implement:
a voice input function which inputs voices of speakers;
a voice print registration function which registers voice prints of the speakers;
a voice extraction function which filters the voices that were input and extracts voices corresponding to the registered voice prints; and
a recording function which records the extracted voices.

20. A voice recorder program that causes a computer to implement:
a voice input function which inputs voices of speakers;
a speaker direction calculation function which calculates directions in which the speakers that emitted the voices are present based on the input voices; and
a recording function which associates and records the directions of the speakers and the voices.
